(19) United States
(12) Patent Application Publication
(10) Pub. No.: US 2005/0258648 A1
(43) Pub. Date: Nov. 24, 2005

(54) Clamp assembly for joining two annular ferrules

(75) Inventor: David W. Newman, Lebanon, OH (US)

Correspondence Address: WOOD, HERRON & EVANS, LLP, 2700 CAREW TOWER, 441 VINE STREET, CINCINNATI, OH, 45202, US

(73) Assignee: Newman Sanitary Gasket Company, Lebanon, OH (US)

(21) Appl. No.: 10/852,360

(22) Filed: May 24, 2004

(51) Int. Cl. F16L 35/00

(52) U.S. Cl. 285/364

(57) ABSTRACT

A clamp assembly for joining a flange of a first annular ferrule to a flange of a second annular ferrule is provided. The clamp assembly comprises a compressible gasket sandwiched between flanges of the first and second ferrules and a clamp for securing the flanges of the first and second ferrules together. The clamp has first and second sections pivotally joined together. A screw assembly comprising a screw and a thumb piece rotatable on the screw tightens the clamp such that the gasket is compressed. The clamp design prevents over compression of the gasket.

### FIELD OF THE INVENTION

This invention relates generally to clamp assemblies and more particularly to clamp assembly for joining two annular ferrules.

### BACKGROUND OF THE INVENTION

In the pharmaceutical industry, annular ferrules are commonly attached to the ends of pipes via welding or any other suitable techniques. In order to join adjacent ferrules together, clamp assemblies are used. Such clamp assemblies commonly have a pair of C-shaped clamp sections hingedly connected on one end, and are joined at the opposite ends with a thumb screw. As disclosed in U.S. Pat. No. 3,744,825 for example, these clamp assemblies secure two adjacent ferrules together with a gasket sandwiched between the ferrules to prevent leakage of fluids which flow through the pipes to which the ferrules are attached.

In known clamp assemblies, an operator may over-torque the thumbscrew of the clamp and thereby displace the gasket so the gasket extends into the interior passageway or flow path of the ferrules. A gasket extending into the flow path between the pipes inhibits the flow therethrough and may create a buildup or backup of material on the upstream side of the displaced gasket which may contaminate later runs or flows. Furthermore, over-torquing of the clamp may damage the gasket to the point of cutting the gasket, thereby reducing its effectiveness.

Therefore, there is a need for a clamp assembly including a gasket sandwiched between two annular ferrules and clamp which can not be over-torqued by an operator. There is further a need in the industry for a clamp assembly including a clamp having a thumbscrew which when fully tightened, compresses a gasket sandwiched between annular ferrules so the inside surface of the gasket sits flush with the inside surface of the flow path and the gasket does not impede fluid flow through the clamp assembly.

### SUMMARY OF THE INVENTION

The present invention comprises a clamp assembly for joining a flange of a first annular ferrule to a flange of a second annular ferrule. Both of the annular ferrules have an inside circular opening of equal diameter which defines a flow path between the pipes or tubes to which the annular ferrules are attached. The clamp assembly comprises two principal components: a compressible gasket adapted to be sandwiched between the flanges of the first and second ferrules and a clamp for securing the flanges of the first and second ferrules together.

The compressible gasket is generally circular and has a pair of opposed side walls the distance between which defines the thickness of the gasket. The compressible gasket also has a generally circular outer surface which defines the outer diameter of the gasket. The gasket has an inside circular opening of approximately the same diameter as the inside circular openings of the ferrules. The gasket may be made of any suitable compressible materials, such as silicone, viton, or any similar material.

The clamp is preferably made of stainless steel, but may be made of any other suitable material. The clamp has arcuate or curved first and second sections, each having a proximal end and a distal end. The proximal ends of the first and second sections are pivotally connected together so that the clamp may be opened and closed about a pivot point. Each of the clamp sections has an inner groove therein adapted to receive both of the flanges of the first and second annular ferrules, the compressible gasket being sandwiched therebetween. Each of the sections has an ear extending outwardly from a distal end thereof, each of the ears having a cut-out portion.

The clamp further includes a screw assembly comprising a screw and a thumb piece threadably engaged with the screw. The screw is pivotally secured to one of the ears of one of the clamp sections and passes through the cut-out portion of the other ear of the other section, such that upon rotation of the thumb piece the ears of the clamp are pushed together until contact therebetween is made. Contact between the ears of the clamp prevents an operator from further rotating the thumb piece on the screw assembly and further compressing the gasket to a point of damaging the gasket or causing the gasket to enter the flow path through the annular ferrules.

The compressible gasket is sized such that upon contact of the ears of the clamp via rotation of the thumb piece, the inner diameter of the compressible gasket is substantially equal to the inner diameter of the ferrule openings and actually forms part of the flow path. When the clamp is fully tightened, the gasket does not extend into the flow path defined by the openings of the ferrules. Thus, the configuration of the clamp of the present invention and, more particularly, the configuration of the ears of the first and second sections of the clamp, prevent the gasket from being over compressed and extending into the flow path of the ferrules. When the clamp is fully closed with the ears of the clamp sections touching, the inner diameter of the inside circular opening of the gasket is approximately identical to the diameter of the openings of the annular ferrules, thereby causing the gasket to be part of the flow path through the clamp assembly.

In one alternate preferred embodiment of the present invention, a wedge is rotatably secured on the screw of the clamp so that the wedge is sandwiched between the ears of the clamp. In this embodiment of clamp assembly rotation of the thumb piece of the clamp pushes one of the ears into contact with the wedge, which contacts the other ear, and thereby prevents further rotation of the thumb piece and consequently over compression of the gasket.

In an alternate preferred embodiment of the present invention an identification tag is secured to the compressible gasket. A connector in the form of wire, nylon, or any other plastic extends between the flange of the compressible gasket and the identification tag, which has indicia thereon. Although the identification tag is preferably made of metal, it may be made of any other suitable material. The identification tag identifies the type of gasket and other details which are described in more detail below.

These and other objects and advantages of the present invention will be more readily apparent from the following description of the drawings.

### BRIEF DESCRIPTION OF THE DRAWINGS

FIG. 1 is a perspective view of a prior art clamp assembly which may be over-torqued and consequently over compress a gasket sandwiched between two annular ferrules;

FIG. 2 is a perspective view of one preferred embodiment of the clamp assembly of the present invention when used in connection with two conduits or pipes;

FIG. 3 is a dissembled perspective view of the clamp assembly of FIG. 2;

FIG. 4 is a side elevational view of the clamp assembly of FIG. 2;

FIG. 5 is a perspective view of a compressible gasket made in accordance with the present invention having an identification tag secured thereto;

FIG. 6 is a partially disassembled perspective view of an alternate embodiment of clamp assembly of the present invention; and

FIG. 7 is a side elevational view of the clamp assembly of FIG. 6.

### DETAILED DESCRIPTION OF THE DRAWINGS

Referring to the drawings, particularly to FIG. 1, there is illustrated a prior art clamp assembly 10. This prior art clamp assembly 10 comprises a pair of annular ferrules 12 clamped together with clamp 14. Each of the annular ferrules 12 has a flange 16 between which is sandwiched a gasket 18. Each of the annular ferrules 12 has an inside circular opening 20 of the same diameter or size so that when the flanges 16 of the ferrules 12 are clamped together with clamp 14, a passageway or flow path 22 is created.

The prior art clamp 14 has a first arcuate or curved section 24 and a second arcuate or curved section 26 hingedly secured to hinge members 28 with hinge pins 30. The first section 24 of the clamp 14 has an ear 32 and the second section 26 of the clamp 14 has an ear 34. As seen in FIG. 1, a gap 36 exists between the ears 32, 34.

A screw assembly 38 comprising a threaded screw 40 and a thumb piece 42 rotatable on the screw 40 is used to tighten the clamp 14 and secure the first and second sections 24, 26 of the clamp 14 together. One end of the threaded screw 40 is pivotally secured to ear 32 with hinge pin 31. The threaded screw 40 passes through ear 34. The thumb piece 42 is rotated on screw 40 to pull the ears 34, 36 together.

One drawback to such prior art clamps is that due to the gap 36 between the ears 34, 36 of the first and second sections 24, 26 of the prior art clamp 14, an operator may rotate the thumb piece 42 too much, thereby causing the gasket 18 sandwiched between the flanges 16 of the annular ferrules 12 to be compressed too much. When the gasket 18 is compressed too much, the gasket 18 may extend into the flow path 22, thereby impeding the flow of fluid through the flow path 22. Additionally, the gasket 18 may be compressed so far that it is irreparably damaged and fails to function in its intended manner.

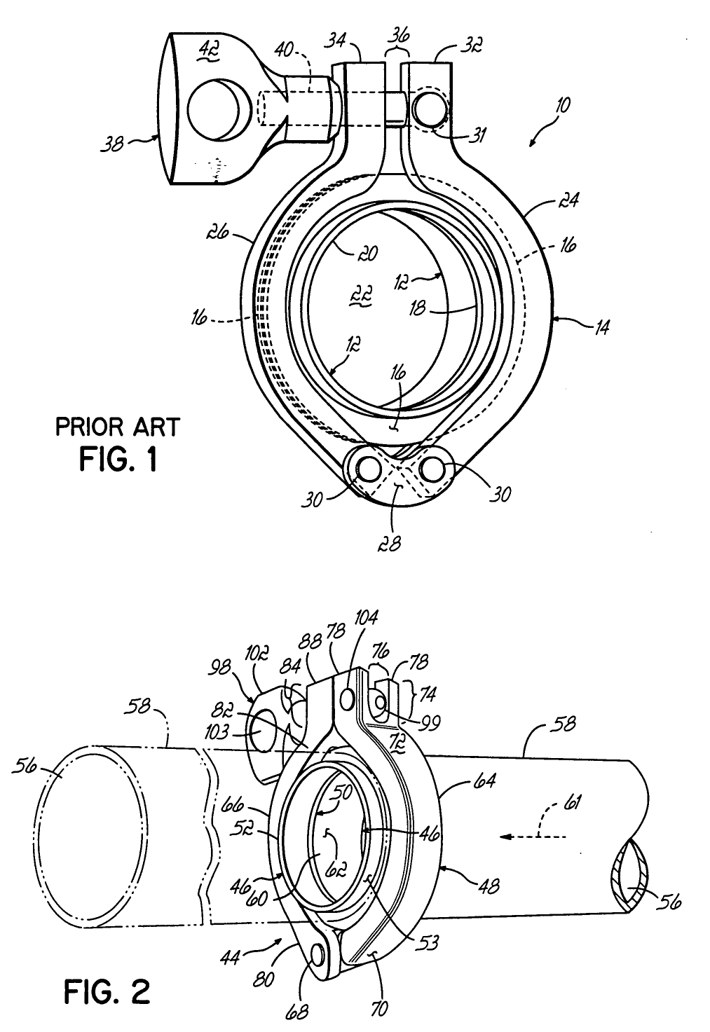

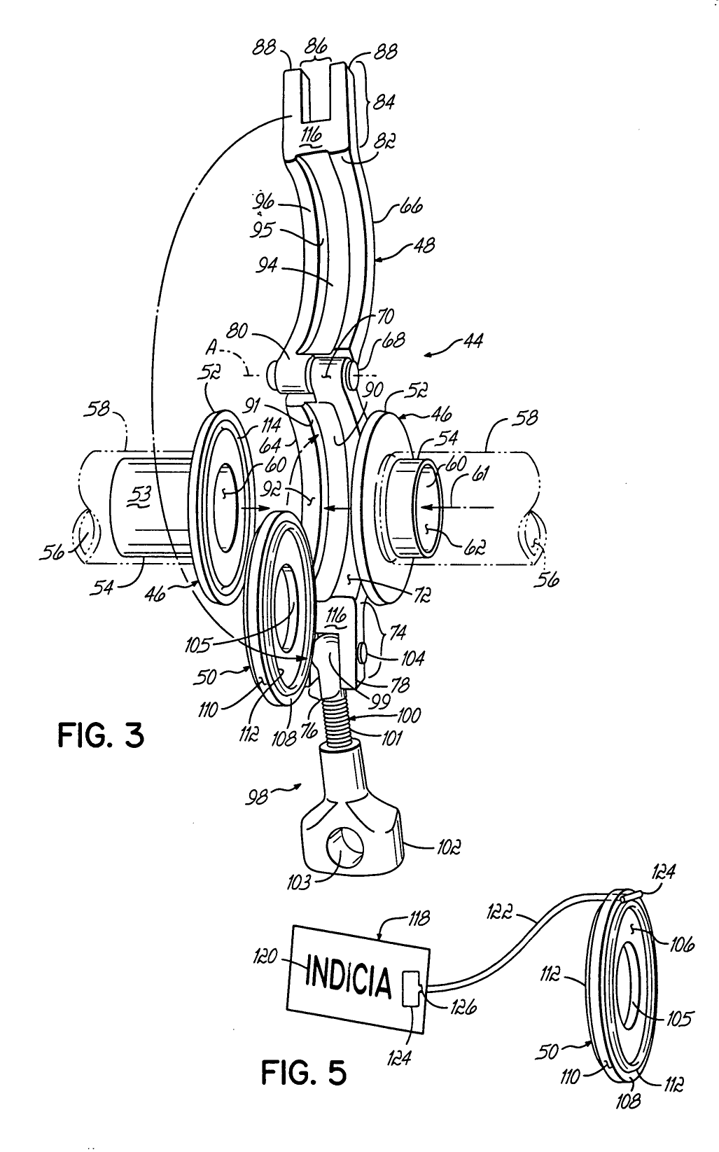

FIG. 2 illustrates one preferred embodiment of clamp assembly 44 in accordance with the present invention. This embodiment of clamp assembly 44 comprises a clamp 48 and a gasket 50 used to join a pair of annular ferrules 46 together. See FIG. 3. As best illustrated in FIG. 3, each of the annular ferrules 46 has a flange 52 and a hub 54. The hubs 54 may the same length or different lengths. The outer surface 53 of the hub 54 of each annular ferrule 46 is welded or otherwise secured to the inside surface 56 of a pipe or conduit 58. Alternatively, the hub 54 of each annular ferrule may be butt welded or otherwise secured to the conduit 58. Each of the annular ferrules 46 has an inside circular opening 60 of the same diameter or size so that when the flanges 52 of the ferrules 46 are clamped together with clamp 48 and tightened in a manner described below, a passageway or flow path 61 is created therebetween. The flow path 61 is defined by the inner surfaces 62 of the hubs 54 of the annular ferrules 46 and includes a portion of the gasket 50.

As best illustrated in FIG. 3, clamp 48 has a first section 64 and a second section 66 hingedly secured to the first section 64 with hinge pin 68. The first section 64 of the clamp 48 has a proximal end 70 through which the hinge pin 68 passes and a distal end 72 from which extends ear 74. The ear 74 of the first section 64 of the clamp 48 has a cutout portion 76 which divides the ear 74 into two ear portions 78. An inner groove 90 having tapered sidewalls 91 is located along the curved or arcuate portion 92 of the first section 64 of the clamp 48, the inner groove 90 being of a width sufficient to receive the flanges 52 of the annular ferrules 46 with the gasket 50 sandwiched between the flanges 52.

Similarly, the second section 66 of the clamp 48 has a proximal end 80 through which the hinge pin 68 passes and a distal end 82 from which extends ear 84. The ear 84 of the second section 66 of the clamp 48 has a cutout portion 86 which divides the ear 84 into two ear portions 88. An inner groove 94 having tapered sidewalls 95 is located along the curved or arcuate portion 96 of the second section 66 of the clamp 48, the inner groove 94 being of a width sufficient to receive the flanges 52 of the annular ferrules 46 with the gasket 50 sandwiched between the flanges 52.

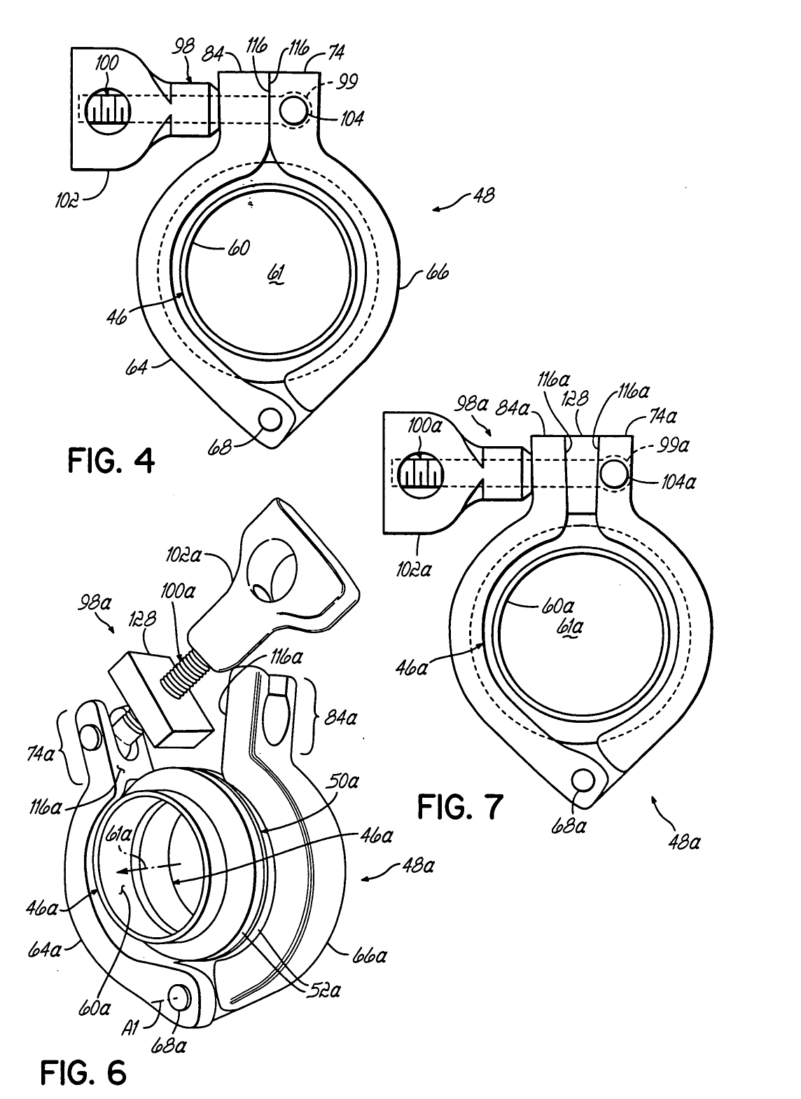

As best illustrated in FIG. 3, a screw assembly 98 comprising a threaded screw 100 having external threads 101 and a thumb piece 102 rotatable on the screw 100 is used to tighten the clamp 48 and secure the ears 74, 84 of the first and second sections 64, 66 of the clamp 48 together. A hole 103 is located in thumb piece 102 to aid in tightening the clamp 48 via rotation of the thumb piece 102. One end 99 of the threaded screw 100 is pivotally secured to ear 74 with a pin 104 which passes therethrough. The end 99 of the threaded screw 100 extends into the cutout portion 76 of the ear 74. The thumb piece 102 is rotated on screw 100 to pull the ears 74, 84 together as shown in FIG. 4.

As shown in FIG. 3, the clamp assembly 44 further comprises a gasket 50 which may be made of silicon, viton or any suitable material. The gasket 50 has an inside circular opening 105 having an inner diameter which is preferably slightly less than the diameter of the inside circular openings 60 of the annular ferrules 46. When the gasket 50 is compressed by pressure exerted on the side walls 106 of the gasket 50 by the flanges 52 of the annular ferrules 46, the diameter of the inside circular opening 105 increases slightly to approximately the same diameter as the inside circular openings 60 of the annular ferrules 46. The gasket 50 also has a flange 108 having an outer surface 110 and a circular lip 112 extending outwardly from each side wall 106 which fits inside a groove 114 formed in the flange 52 of the annular ferrule 46. See FIG. 3.

As shown in FIGS. 3 and 4, the clamp 48 is movable between a closed position shown in FIG. 4 and an open position shown in FIG. 3. In moving between open and closed positions, the first and second sections 64, 66 of the clamp 48 pivot or hinge about axis A defined by the hinge pin 68. See FIG. 3.

As shown in FIG. 4, when the clamp 48 is in its closed position, an operator may rotate the thumb piece 102 of the screw assembly 98 until the inner surfaces 116 of the ears 74, 84 of the first and second sections 64, 66 of the clamp 48 contact each other. Rotation of the thumb piece 102 causes the flanges 52 of the annular ferrules 46 to move towards each other due to the tapered sidewalls 91, 95 of the inner grooves 90, 94 of the first and second sections 64, 66 of the clamp 48. More specifically, the flanges 52 of the annular ferrules 46 to move towards by riding on the tapered sidewalls 91, 95 of the inner grooves 90, 94 of the first and second sections 64, 66 of the clamp 48. Thus, the tapered sidewalls 91, 95 of the inner grooves 90, 94 of the first and second sections 64, 66 of the clamp 48 actually cause compression of the gasket 50 upon tightening of the clamp 48. When the inner surfaces 116 of the ears 74, 84 of the first and second sections 64, 66 of the clamp 48 contact each other, the operator is unable to further rotate the thumb piece 102, thereby preventing the gasket 50 sandwiched between the flanges 52 of the annular ferrules 46 from being further compressed. If the gasket 50 is compressed too much, the gasket 50 may extend into the flow path 61, thereby impeding the flow of fluid through the flow path 61. Thus, the thickness of the ears 74, 84 of the clamp 48 prevents an operator from compressing the gasket 50 so far that it is irreparably damaged and fails to function in its intended manner.

FIG. 5 illustrates an additional aspect of the present invention. If desired an identification tag 118 having indicia 120 printed thereon may be secured to the flange 108 of the gasket 50. The identification tag 118 may be made of metal, plastic or any suitable material. The indicia 120 may include, but is not limited to the following: the material from which the gasket is made, the cure or manufacturing date, the date the gasket was placed in service and the batch number given by the supplier of the material from which the gasket is made. A flexible connector 122 having ends 124 passes through a hole 126 in the identification tag 118 and through the flange 108 of the gasket 50. The ends 124 of the connector 122 prevent the connector 122 from separating from the gasket 50 and/or the identification tag 118. The connector 122 may be made of nylon, wire or any other desired material.

FIGS. 6 and 7 illustrate an alternative preferred embodiment of the present invention. For purposes of simplicity, like numeral designate like parts but with a letter designation. In this alternative preferred embodiment, a wedge 128 is rotatably secured on the screw 100a so that when the thumb piece 102a is fully tightened or rotated, the wedge 128 is sandwiched between the ears 74a, 84a of the clamp 48a. The use of the wedge 128 enables an operator to retrofit a prior art clamp assembly like the one illustrated in FIG. 1 so that an operator may not overcompress the gasket 50a sandwiched between the flanges 52a of the annular ferrules 46a. Although one configuration of wedge 128 is illustrated in FIGS. 6 and 7, the wedge 128 may assume other configurations without departing from the spirit of the invention.

As shown in FIGS. 6 and 7, the clamp 48a is movable between a closed position shown in FIG. 7 and an open position shown in FIG. 6. In moving between open and closed positions, the first and second sections 64a, 66a of the clamp 48a pivot or hinge about axis A1 defined by the hinge pin 68a. See FIG. 6.

As shown in FIG. 7, when the clamp 48a is in its closed position, an operator may rotate the thumb piece 102a of the screw assembly 98a until the inner surfaces 116a of the ears 74a, 84a of the first and second sections 64a, 66a of the clamp 48a contact the wedge 128. When these surfaces 116a contact the wedge 128, the operator is unable to further rotate the thumb piece 102a, thereby preventing the gasket 50a sandwiched between the flanges 52a of the annular ferrules 46a from being compressed too much. If the gasket 50a is compressed too much, the gasket 50a may extend into the flow path 61a, thereby impeding the flow of fluid through the flow path 61a. Thus, the thickness of the ears 74a, 84a of the clamp 48a along with the wedge 128 prevents an operator from compressing the gasket 50a so far that it is irreparably damaged and fails to function in its intended manner.

While I have described several preferred embodiments of the present invention, persons skilled in the art will appreciate changes and modifications which may be made without departing from the spirit of the invention. For example, although one configuration of wedge is illustrated and described, the present invention may be used with other configurations of wedges. Therefore, I intend to be limited only by the scope of the following claims and equivalents thereof:

1. A clamp assembly for joining a flange of a first annular ferrule to a flange of a second annular ferrule, both of said annular ferrules having an inside circular opening of equal diameter, said clamp assembly comprising:
a compressible gasket sandwiched between the flanges of the first and second ferrules, said gasket having an inside circular opening having an inner diameter;
a clamp for securing the flanges of the first and second ferrules together, said clamp having first and second sections pivotally joined together, each of said sections having an ear;
a screw assembly comprising a screw and a thumb piece rotatable on said screw, wherein said screw is secured to one of said ears of said clamp and passes through the other of said ears of said clamp such that upon rotation of said thumb piece, said ears of said clamp contact each other preventing further rotation of said thumb piece of said screw assembly and further compression of the compressible gasket,
said compressible gasket being sized such that upon contact of said ears of said clamp said inner diameter of said compressible gasket is substantially equal to the diameter of the ferrule openings.

2. The clamp assembly of claim 1 wherein said inner diameter of the compressible gasket is approximately the same diameter as the inside openings of the ferrules.

3. The clamp assembly of claim 1 wherein said screw of said screw assembly is pivotally secured to said one of said ears of said clamp.

4. The clamp assembly of claim 1 wherein said screw assembly includes a wedge rotatable on said screw.

5. The clamp assembly of claim 1 further comprising an identification tag secured to the compressible gasket.

6. The clamp assembly of claim 5 wherein a piece of wire extends between the compressible gasket and the identification tag.

7. The clamp assembly of claim 6 wherein said piece of wire passes through a flange of said compressible gasket.

8. A clamp assembly for joining a flange of a first annular ferrule to a flange of a second annular ferrule, both of said annular ferrules having an inside circular opening of equal diameter, said clamp assembly comprising:
a compressible gasket sandwiched between the flanges of the first and second ferrules, said gasket having side walls and an inside circular opening having an inner diameter;
a clamp for securing the flanges of the first and second ferrules together, said clamp having arcuate first and second sections pivotally joined together, each of said sections having an inner groove therein and an ear extending outwardly from a distal end thereof, each of said ears having a cutout portion;
said clamp further comprising a screw assembly pivotally secured to one of said ears of one of said seconds, said screw assembly comprising a screw and a thumb piece rotatable on said screw, wherein said screw is pivotally secured to said one of said ears of said clamp and passes through the cutout portion of the other of said ears of said clamp such that upon rotation of said thumb piece, said thumb piece forces said ears of said clamp to contact each other preventing further rotation of said thumb piece of said screw assembly and further compression of the compressible gasket,
said compressible gasket being sized such that upon contact of said ears of said clamp said inner diameter of said compressible gasket is equal to the diameter of the ferrule openings and said side walls of said gasket sealingly contact the flanges of both of said ferrules.

9. The clamp assembly of claim 8 wherein said screw of said screw assembly is pivotally secured to said one of said ears of said clamp.

10. The clamp assembly of claim 8 further comprising an identification tag secured to the compressible gasket.

11. The clamp assembly of claim 10 wherein a piece of wire extends between the compressible gasket and the identification tag.

12. The clamp assembly of claim 11 wherein said piece of wire passes through a flange of said compressible gasket.

13. The clamp assembly of claim 10 wherein said identification tag is metal.

14. A method of securing first and second ferrules together, said method comprising:
providing a clamp having two sections pivotally joined together, each of said sections having an inner groove and an ear, said clamp having a thumbscrew pivotally secured to one of said ears;
sandwiching a compressible gasket between flanges of the first and second ferrules;
placing said flanges of said first and second ferrules in said inner grooves of said sections of said clamp;
passing the thumbscrew through the other of said ears; and
rotating the thumbpiece on said thumbscrew until said ears of said sections of said clamp contact each other and said gasket has an inner diameter equal to the inner diameter of the first and second ferrules.

15. A clamp assembly for joining a flange of a first ferrule to a flange of a second ferrule, said clamp assembly comprising:
a compressible gasket sandwiched between the flanges of the first and second ferrules;
a clamp for securing the flanges of the first and second ferrules together, said clamp having arcuate first and second sections pivotally joined together, each of said sections having an ear extending outwardly from a distal end thereof, each of said ears having a cutout portion;
said clamp further comprising a screw assembly comprising a screw, a wedge and a thumb piece rotatable on said screw, said screw being pivotally secured to one of said ears of one of said sections and passing through the cutout portion of the other of said ears of said clamp such that upon rotation of said thumb piece, said thumb piece forces said ears of said clamp to sandwich said wedge therebetween, preventing further compression of the compressible gasket,
said compressible gasket being sized such that upon contact of said ears of said clamp said inner diameter of said compressible gasket is equal to the inner diameter of the ferrules.

16. The clamp assembly of claim 15 further comprising an identification tag secured to the compressible gasket.

17. The clamp assembly of claim 16 wherein a piece of wire extends between the compressible gasket and the identification tag.

18. The clamp assembly of claim 17 wherein said piece of wire passes through a flange of said compressible gasket.

19. The clamp assembly of claim 16 wherein said identification tag is metal.

20. A method of securing first and second ferrules together, said method comprising:
providing a clamp having two sections pivotally joined together, each of said sections having an inner groove and an ear, said clamp having a thumbscrew pivotally secured to one of said ears;
sandwiching a compressible gasket between flanges of the first and second ferrules;
placing said flanges of said first and second ferrules in said inner grooves of said sections of said clamp;
passing the thumbscrew through the other of said ears; and
rotating a thumbpiece on said thumbscrew until a wedge is sandwiched between said ears of said sections of said clamp and said gasket has an inner diameter equal to the inner diameter of the first and second ferrules.
